(19) United States
(12) Patent Application Publication
(10) Pub. No.: US 2009/0263520 A1
(43) Pub. Date: Oct. 22, 2009

(54) NEMATICIDAL COMPOSITION

(75) Inventor: David Marks, Witherslack (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Plant Impact PLC, Manchester, Lancashire (GB)

(21) Appl. No.: 12/300,637

(22) PCT Filed: May 14, 2007
(86) PCT No.: PCT/GB07/01767

§ 371 Date: Mar. 13, 2009

(30) Foreign Application Priority Data
May 12, 2006 (GB) 0609436.1

(51) Int. Cl. A01N 65/22; A01P 5/00

(52) U.S. Cl. 424/774

(57) ABSTRACT

A nematicidal composition comprising (i) one or more essential oils selected from Tagetes erecta oil, Ocimum basilicium (sweet basil) oil or a Cymbopogon martini (palmerosa) oil, or a mixture thereof, or certain components thereof which have nematicidal effect (ii) an agriculturally acceptable carrier oil and (iii) an emulsifier.

The present invention relates to pesticidal compositions, in particular to compositions that control nematode pests and their use, especially in agriculture.

It has been reported previously that natural control of nematode pests may be effected naturally by planting marigolds (Tagetes species) in the vicinity of crop plants.

Furthermore, it has been reported that a variety of essential oils may be utilised in nematode control (see for example Oka et al., (2000) Phytopathology, Vol. 90, 7, 710-715). Many of these have been oils which contain thymol. WO 00/53020 describes nematicidal compositions containing plant essential oil compounds, and in particular eugenol or eugenol containing mixtures.

Furthermore, the potential for use of essential oils in mainstream agriculture is limited due to two factors: economics and taint. Generally speaking, these oils, are quite costly, in particular in the high doses in which they are required to be used effectively. Furthermore, when used in high quantities, the crops treated can suffer significant post harvest taint.

The applicants have found however, that when formulated in a particular way, a specific set of certain oils are highly effective at controlling nematode pests.

According to the present invention there is provided a nematicidal composition comprising (i) one or more essential oils selected from Tagetes erecta oil, Ocimum basilicium (sweet basil) oil or a Cymbopogon martini (palmerosa) oil, or a mixture thereof, or a component of any of these which has a nematicidal effect (ii) an agriculturally acceptable carrier oil and (iii) an emulsifier. Where components are used, they are suitably other than eugenol.

As used herein, the term “nematicidal” includes both nematode killing and repellency effects.

In particular, the composition comprises Cymbopogon martini (palmerosa) oil or Tagetes erecta oil, and especially Cymbopogon martini (palmerosa) oil or a nematicidal component thereof.

One or more isolated components of these oils may be utilised in the compositions, provided these have nematicidal properties.

Components of Tagetes erecta essential oil include dihydrotagetone, thiophenes and ocimene, or which dihydrotagetone is the most important component.

In the case of Ocimum basilicium (sweet basil) oil, components include terpenoids, particularly linalool, eugenol, thymol, and estragole.

Finally components of Cymbopogon martini (palmerosa) oil include geraniol.

Thus components which may be used include dihydrotagetone, thiophenes, ocimene, linalool, thymol, estragole, and geraniol. Particular components for use in the composition of the invention include geraniol, dihydrotagetone, linalool or thymol, and especially geraniol or dihydrotagetone.

Any of these components can be tested using routine methods, for example as described hereinafter, to determine whether or not they have nematicidal properties. If they do, they may be utilised in place of the essential oil itself.

Preferably however, composition comprises as component (i) one or more essential oils selected from Tagetes erecta oil, Ocimum basilicium (sweet basil) oil or a Cymbopogon martini (palmerosa) oil, or a mixture thereof.

The agriculturally acceptable carrier oil acts as a carrier for the essential oil, allowing a smaller quantity of the essential oils to be distributed through the soil, thus improving efficacy and reducing phytotoxicity. Furthermore, in the case of root crops, such as potato, carrot, turnips, chicory, parsnips etc., the use of smaller quantities of essential oils can lead to a reduction in any taint problems.

The composition suitably contains no more than 5% w/w of any one essential oil, for example no more than 4% w/w of the or each essential oil, more suitably no more than 3% w/w and preferably no more than 2% w/w of the or each essential oil. For instance, the composition may contain from 0.5% w/w-5% w/w of each essential oil, for example from 1% w/w-5% w/w.

Thus the composition will suitably have no more than 15% w/w total essential oil content, for example no more than 12% w/w, more suitably no more than 9 and probably no more than 6% w/w total essential oil. Depending upon the nature of the oil and the nematode problem being addressed, the composition may comprise no more than 4% w/w, or even 3% w/w or 2% w/w essential oil.

Using formulations of this type, effective nematode control can be achieved by applying for instance from 1-20 litres per hectare, such as from up to 10 litres per hectare of the composition to the soil surrounding crops. In many cases, administration of from 2 to 5 litres per hectare will be appropriate.

This represents a significant reduction, for instance a reduction of between one and two orders of magnitude, of the amount of essential oil applied, as compared to the conventional methods of using these active ingredients in nematode control.

The low concentrations of active components used in the compositions of the invention provides environmental benefits. In particular, adverse effects against beneficial insects such as bees, ladybirds (Coccinella septempuncata) and earthworms (Eisenia foetida) or beneficial soil microorganisms are minimised.

Thus in a particular embodiment, the composition contains a mixture of at least two of the oils specified as possible components (i) above, which show synergistic effects when used together in the control of nematodes. For example the composition may comprise a combination of Tagetes erecta oil and Ocimum basilicium (sweet basil) oil, a combination of Tagetes erecta oil and Cymbopogon martini (palmerosa) oil, or a combination of Ocimum basilicium (sweet basil) oil and Cymbopogon martini (palmerosa) oil.

It is generally accepted that synergy occurs when the combined effects of the components is better than one might expect from a study of the effects of individual components. This will not be a simple additive effect, since it would be normally expected that many of the nematodes that succumbed to one essential oil would also succumb to another and so the populations are not distinct. However, whether or not a percentage increase in nematicidal effect as a result of synergistic activity between components is readily calculable using formulae which are well known in the art.

A very simple formula is represented as follows:

Where X=percentage nematodes killed by component (A) alone

Where Y=percentage nematodes killed by component (B) alone

Where Z=percentage nematodes killed by combination of A+B Synergy occurs if Z>X+Y(100−X)

The determination of X, Y and Z above can be readily carried out using routine testing methods, for example as described below in Example 2. Therefore, the determination of synergy of any particular combination is possible.

In a further particular embodiment, the composition comprises a mixture of all three oils, each being present in amounts as described above, but preferably in ratios which give rise to synergistic effects. As a result, it is possible to reduce the dosage of the essential oils still further.

Suitable ratios of the various essential oils using in the mixtures will vary depending upon the optimum synergy values achievable, as well as the particular nematode problem being treated. Generally however, the amount of any single oil will not exceed three times the amount of any other oil within the composition. In one embodiment, the composition comprises approximately equal quantities of each of the essential oils.

In particular, the applicants have found that combinations of tagetes oil and palmerosa oil act synergistically together in the control of nematodes, and so compositions comprising at least these two oils (or nematicidally active components thereof) form a particular embodiment of the invention.

The composition may additionally comprise other oils, in particular sweet basil oil and/or thyme oil, although in a further particular embodiment, the composition comprises all four oils. Synergy in particular has been noted when this combination has been used.

The agriculturally acceptable carrier oil is suitably a vegetable oil such as including canola oil (OSR), sunflower oil, cottonseed oil, palm oil or soybean oil. In a particular embodiment, the oil is canola oil.

The composition of the invention comprises an emulsifier, which may be any known agriculturally acceptable emulsifier. In particular, the emulsifier will comprise a surfactant, typically alkylaryl sulphonates, ethoxylated alcohols, polyalkoxylated butyl ethers, calcium alkyl benzene sulphonates, polyalkylene glycol ethers and butyl polyalkylene oxide block copolymers as are known in the art.

Nonyl phenol emulsifiers such as Triton N57™ are particular examples of emulsifiers, which may be used in the compositions of the invention, as are polyoxyethylene sorbitan esters such as polyoxyethylene sorbitan monolaurate (sold by ICI under the trade name “Tween™”). In some instances, natural organic emulsifiers may be preferred, particularly for organic farming applications. Coconut oils such as coconut diethanolamide is an example of such an compound. Palm oil products such as Lauryl stearate may also be used.

The emulsifier is suitably present in an amount which is sufficient to ensure that the composition has the desired miscibility with water. For instance, the emulsifier may be present in amounts of from 1 to 20% w/w, suitably up to 10% w/w and in particular about 5% w/w.

In a particular embodiment, the composition of the invention further comprises (iv) a component which remediates symptoms of viral infection. Particular examples of such compounds may be compounds which reduce ethylene production or have antiviral effects.

Ethylene production is increased following infection with many viruses, and application of compounds, which reduce this, can be used to remediate symptoms.

A particular example of compounds which are known to reduce ethylene production are salicylate compounds such as salicyclic acid or esters thereof, in particular alkyl ester. Examples of alkyl esters include c₁₋₁₀alkyl esters such as methyl salicylate.

Suitably, the salicylate compound used in the composition is in the form of an essential oil. Examples of essential oils which include salicylic acid or salicylates include wintergreen oil, as well as oils from Chenopodium, Erythroxylum, Eugenia, Gaultheria, Myristica, Syzygium, xanthophyllum, Cinnamonium, Gualtheria, Gossypium and mentha.

For example, wintergreen oil contains a high proportion of methyl salicylate, and therefore forms a readily useable source of active ingredient, which is readily miscible with the composition.

Alternatively or additionally, the compound used may be used compounds which have antiviral activity and such as jasmonic acid or derivatives thereof. Particular derivatives are alkyl esters such as C₁₋₁₀alkyl esters such as methyl jasmonate.

The composition of the invention need only contain a relatively small amount of such a compound, for example up to 1.0% w/w, suitably up to 0.5% w/w, and preferably only a trace amount up to 0.1% w/w or even 0.005% w/w for instance, 0.001% w/w. Where this is administered in the form of an essential oil, the amount of oil added should be sufficient to ensure that the desired concentration of the active compound is supplied. In this context, oils with relatively high concentrations of the compounds, such as wintergreen oil, may be preferred.

Thus a particularly preferred composition comprises wintergreen oil as component (iv) as described above.

In this particular embodiment, the composition can be used as a “one product strategy” for dealing with several separate but related issues. Specifically it can tackle nematodes and the virus that they vector by:
a) Destroying nematodes already present;
b) Deterring reinfestation; and
c) Helping the plant recover from any virus.

The combined approach yields better results than using separate materials.

In particular, compositions of the invention are useful in treating Cyst nematodes and root knot nematodes, and in particular Cyst nematodes such as Potato Cyst nematodes (PCN).

Compositions are suitably prepared by mixing the components together in a conventional manner. Suitably, the essential oil(s), the viral symptom remediation component and the emulsifier are added to the agriculturally acceptable carrier oil and mixed with stirring until the components are evenly diluted throughout the composition.

The compositions of the invention are suitably diluted in water before application. Thus the compositions described above are generally concentrates.

Thus in a further aspect, the inventions provide a formulation for administration to soil containing or suspected of containing nematode pests, a formulation comprising a composition as described above, and water. The soil will either contain crops or the formulation may be applied before crops have been planted as a preparation procedure.

The amount of water used will depend upon the particular mode of administration of the nematicidal formulation, and to where it is being applied, for example to soil or crops or the like. This may be by means of a sprayer, such as an electrostatic or other conventional sprayer, or it may be applied more directly to the soil for example using irrigation and in particular drip irrigation methods. In general, the final formulation will contain from 0.1-7% v/v, preferably from 0.6-7% and suitably at about 4-6% v/v of the composition of the invention and the remainder is water.

In yet a further aspect, the invention provides a method for killing or controlling nematodes which method comprises applying to the nematodes or to the locus thereof, a composition as described above.

Suitably, the composition is one that contains a component, which remediates viral infection, and so the treatment provides a combined pesticidal and viral symptom remediation effect.

Nematode pests which may be treated with the compositions and methods described above include wheat nematodes (Anguina tritici), grass seed nematodes (Anguina agrostis), Spring dwarf nematodes (Aphelenchoides fragariae), pine wood nematodes (Bursaphelenchus xylophylus), chrysanthemum nematodes (Aphelenchoides ritzema-bosi), bulb and stem nematodes (Ditylenchus dipsaci), potato rot nematodes (Ditylenchus destructor), root lesion nematodes (Pratylenchus ap.), root-knot nematodes (Meloidogyne sp.), Cyst nematodes (Heterodera sp.), cyst nematodes (Globodera spp.), stubby-root nematodes (Trycodorus sp), dagger nematodes (Xiphinema sp.), needle nematodes (Longidorus sp.), pin nematodes (Paratylenchus sp.), stunt nematodes (Tylenchorhynchus sp.), lance nematodes (Hoplolaimus sp.), spiral nematodes (Helicotylenchus sp.) and ring nematodes (Criconema sp.).

Of these, the most important nematode pests which may be treated as described herein include bulb and stem nematodes (Ditylenchus dipsaci), potato rot nematode (Ditylenchus destructor), root lesion nematodes (Pratylenchus sp.), root-knot nematodes (Meloidogyne sp.), cyst nematodes (Heterodera sp.) and cyst nematodes (Globodera spp.)

The product is suitable for use on most crops, but in particular can be used for the treatment of greenhouse crops, vegetables, in particular root vegetables such as potato, and fruit crops.

The compositions have low phytotoxicity at the effective concentrations. They appear to act as contact nematicides and may not be well translocated through plant tissue. However, they do persist well when applied to soil, and so provide reasonable protection over a period of time.

The invention further provides the use of a composition as described above which contain a compound which remediates viral symptoms, as a combined nematicidal/viral symptom remediation composition.

The composition or formulation described above may be used alone or they may be used in combination with other agrochemicals such as herbicides, fungicides, insecticides or plant growth regulators.

In a particular embodiment, the invention provides the use of a composition as described above as a nematicide, for administration to soil at a rate of less than 5 litres per hectare, and preferably at no more than 2 litres per hectare.

The amount of composition applied in any particular situation will vary depending upon a number of factors such as the nature of the crop, the level of infestation etc. Typically however, up to 20, for example up to 10, and suitably from 2-5 litres of the composition described above before water is added, will be applied per hectare. Thus the amount of essential oil added will generally be up to 0.2 litres per hectare, and suitably from 0.02 to 0.5 litres per hectare. This is significantly lower than conventional methods.

The invention will now be particularly described by way of example.

### EXAMPLE 1

### Compositions

A range of compositions were prepared using the following components, which were mixed together in the amounts listed in Table 1:

TABLE 1

| Component | % w/w of total |
|---|---|
| Canola (Oilseed rape) Oil | 93.0 |
| Essential oil under test * | 2.0 |
| Polysorbate 20 | 5.0 |

* See Table 2

TABLE 2

| Composition No. | Essential oils under test |
|---|---|
| 1 | Palmerosa Oil |
| 2 | Sweet Basil Oil (Linalool) |
| 3 | Tagetes Oil (Tagetes erecta) |
| 4 | Thyme oil |

A further composition (Composition 5) was prepared by combining the following components:

| Component | % w/w of total |
|---|---|
| Canola Oil | 94.5 |
| Wintergreen oil | 0.5 |
| Emulsifier (Polysorbate 20) | 5.0 |

A control composition (Composition 6) was prepared by mixing the following components

| Component | % w/w of total |
|---|---|
| Canola (Soybean) Oil | 95.0 |
| Emulsifier (Polysorbate 20) | 5.0 |

All compositions had a similar appearance; all were light yellow, clear liquids.

### EXAMPLE 2

### Control of Nematodes

Each of the compositions described in Example 1 was screened for nematicidal effects by assessing juvenile nematode (J2) mobility in the potato cyst nematode Globodera sp.

Potato cyst nematodes (PCN), Globodera sp. were obtained from a sample of soil (approx. 5 kg), potato roots and potatoes obtained from a PCN-contaminated site.

PCN were used in this study because it is a commercially important plant pest, it is readily available and easy to handle in the laboratory.

Viable PCN cysts were collected by sieving using a method based on the flask method described by EPPO (1997) Phytosanitary procedures Globodera pallida and G. rostochiensis soil sampling methods. European and Mediterranean Plant Protection Organization. PM 3/30 (1). An amount of soil was mixed with water in 250 mL beakers, the cysts floated to the surface and the surface water was washed through 850 μm and 355 μm sieves. The cysts were collected in the 355 μm sieve. They were washed from the sieve into a separate beaker, collected by Pasteur pipette and placed into six-well plates containing tap water.

The cysts were held in the dark in a temperature controlled room (20° C.) for one month. The water in the wells was then replaced with 0.45 μm filtered potato root extract from potato varieties Charlotte and Sante grown in a plant growth room. Hatching started two days after addition of the extract and sufficient numbers of J2 nematodes to start the study were hatched within five days.

Once the nematodes were hatched the methods used to test for effects on immobility were based on those described by Oka et al (2000) Phytopathology Vol 90 no. 7.

Test solutions of the compositions described in Example 1 were prepared by diluting the compositions in aerated tap water (pH 8.18) at 20° C. to form 5% v/v concentrations.

The method used was based on that described by the Organisation for Economic Co-operation and Development (OECD) (2000) Revised draft guidance document on aquatic toxicity testing of difficult substances and mixtures. OECD Environmental Health and Safety Publications. Series on Testing and Assessment. TG\Diffsub\Rev2-9912-S2.doc., for the testing of partially soluble materials in aquatic systems. This involved the preparation of water accommodated fractions (WAFs) of the materials.

5.0 mL volumes of the compositions of Example 1 were made up to 100 mL volumes in volumetric flasks. The dilutions were vigorously stirred by magnetic stirrer at high speed for one hour. The dilutions were, transferred to 250 mL beakers.

All dilutions had a separated layer which formed quickly on the surface with the bulk of the dilutions having either a cloudy white or cloudy yellow appearance.

Thereafter 5 ml of the test solutions were taken by pipette avoiding the settled layer on the surface, after allowing a 30-minute period of separation, and put into each well of six-well polystyrene culture plates with each well having a diameter of 34 mm and a depth of 19 mm.

Four replicate wells were used for each treatment with nominally 10 J2 nematodes added per well (actual numbers added were 6-18 per well).

The air temperature was monitored at 30-minute intervals in the test cabinet using Comark ICESPY electronic logging equipment. During the test period the temperature ranged from 18.3-20.0° C.

Observations on the J2 nematodes were made on days 2, 8 and 14.

Exposure was ended on day 14.

Relatively few nematodes were mobile in any of the wells on day 2. On day 8 and day 14 considerably more nematodes were moving.

On day 14 up to eight drops of a 33% HNO₃ solution were added to stimulate movement of the nematodes.

The data for immobility, after arcsin square root transformation, was analysed for conformance with the assumptions of ANOVA using TOXCALC Version 5.0. Immobility data at each treatment was tested for significant (P=0.05, 1-tailed) differences from the aerated water control using suitable multiple comparison procedures (e.g. Dunnetts test). Dose-response plots were also constructed for each treatment.

The numbers of nematodes added to each well at the start, the numbers mobile at days 8 and 14 and the percentage immobile at day 8 and 14 for each well are shown in Table 3 and are summarised in Summary Table 4.

The numbers of nematodes added to each well at the start, the numbers mobile at days 8 and 14 and the percentage immobile at day 8 and 14 for each well are shown in Table 3 and are summarised in Summary Table 4.

TABLE 3
Results of the assessment of immobility of PCN
J2 nematodes in plant oils.

| | | | | mobile | % | % |
|---|---|---|---|---|---|---|
| Comp. | | number | mobile | at day | immobile | immobile |
| No. | Replicate | at start | at day 8 | 14 | at day 8 | at day 14 |
| Aerated | 1 | 16 | 9 | 9 | 43.8 | 43.8 |
| water | 2 | 10 | 6 | 3 | 40.0 | 70.0 |
| control | 3 | 14 | 5 | 5 | 64.3 | 64.3 |
| | 4 | 15 | 8 | 8 | 46.7 | 46.7 |
| | | | | mean: | 48.7 | 56.2 |
| 6 | 1 | 13 | 5 | 4 | 61.5 | 69.2 |
| Control | 2 | 12 | 7 | 7 | 41.7 | 41.7 |
| | 3 | 15 | 9 | 2 | 40.0 | 86.7 |
| | 4 | 18 | 10 | 10 | 44.4 | 44.4 |
| | | | | mean: | 46.9 | 60.5 |
| 1 | 1 | 9 | 1 | 1 | 88.9 | 88.9 |
| | — | — | — | — | — | — |
| | 3 | 12 | 1 | 1 | 91.7 | 91.7 |
| | 4 | 12 | 0 | 0 | 100.0 | 100.0 |
| | | | | mean: | 93.5 | 93.5 |
| 2 | 1 | 7 | 2 | 1 | 71.4 | 85.7 |
| | 2 | 12 | 2 | 2 | 83.3 | 83.3 |
| | 3 | 9 | 2 | 2 | 77.8 | 77.8 |
| | 4 | 10 | 1 | 0 | 90.0 | 100.0 |
| | | | | mean: | 80.6 | 86.7 |
| 3 | 1 | 10 | 4 | 4 | 60.0 | 60.0 |
| | 2 | 13 | 3 | 3 | 76.9 | 76.9 |
| | 3 | 10 | 4 | 0 | 60.0 | 100.0 |
| | 4 | 10 | 4 | 1 | 60.0 | 90.0 |
| | | | | mean: | 64.2 | 81.7 |
| 4 | 1 | 9 | 5 | 5 | 44.4 | 44.4 |
| | 2 | 6 | 5 | 5 | 16.7 | 16.7 |
| | 3 | 8 | 5 | 5 | 37.5 | 37.5 |
| | 4 | 12 | 4 | 4 | 66.7 | 66.7 |
| | | | | mean: | 41.3 | 41.3 |
| 5 | 1 | 12 | 5 | 5 | 58.3 | 58.3 |
| | 2 | 10 | 7 | 7 | 30.0 | 30.0 |
| | 3 | 13 | 5 | 2 | 61.5 | 84.6 |
| | 4 | 14 | 5 | 5 | 64.3 | 64.3 |
| | | | | mean: | 53.5 | 59.3 |

— = no nematodes added to this well in error

The data (arcsin square root transformed) for days 8 and 14 were analysed using the ToxCalc computer program by comparing the aerated water only controls with each of the plant oils, and the carrier, in turn using appropriate multiple comparison tests (1-tail, P=0.05).

SUMMARY TABLE 4
Mean percentage immobility for day 8 and day 14.

| Treatment/Composition | % immobile at | % immobile at |
|---|---|---|
| number | day 8 | day 14 |
| Water control | 48.7 | 56.2 |
| 6 (Control) | 46.9 | 60.5 |
| 1 | [93.5] | [93.5] |
| 2 | [80.6] | [86.7] |
| 3 | 64.2 | [81.7] |
| 4 | 41.3 | 53.9 |
| | | 41.3 |
| 5 | 53.5 | 59.3 |

Note:
values in bold type and [ ] are significantly different (1-tail, P = 0.05) from the water control.

Palmerosa oil showed the greatest activity against the nematodes, but sweet basil oil and tagetes oil showed good levels of activity. In this trial, thyme oil was ineffective.

### EXAMPLE 3

### Synergy Studies

The study was designed to assess the nematicidal effects of combinations of Thyme Oil 2% w/w, Sweet Basil Oil (Linalool) 2% w/w, Tagetes Oil 2% w/w, Palmerosa Oil 2% w/w and Wintergreen oil 0.5% w/w on juvenile nematode survival in the potato cyst nematode Globodera sp.

The following mixtures of the compositions described in Tables 1-2 of Example 1 were prepared and use in the following treatments regime
A) water-only control
B) mixture of composition 1 (palmerosa oil), composition 2 (sweet basil oil) and composition 3 (tagetes oil) (1:1:1)
C) mixture of composition 1 (palmerosa oil) and composition 2 (sweet basil oil) (1:1)
D) mixture of composition 1 (palmerosa oil) and composition 3 (tagetes oil) (1:1)
E) mixture of composition 2 (sweet basil oil) and composition 3 (tagetes oil) (1:1)
F) mixture of composition 1 (palmerosa oil), composition 2 (sweet basil oil), composition 3 (tagetes oil) and composition 4 (thyme oil) (1:1:1:1)

The concentrations tested included 5.0% v/v in water of the combined mixtures of the plant oils. Water accommodated fractions of the oils in water were tested by vigorously mixing the oils in water for two hours and then removing the aqueous layer for testing after allowing a 30 minute period of separation.

For the three oil mixture (mixture B), 1.67 mL of each oil were made up to 100 mL.

For two oil mixtures (mixtures C, D and E), 2.5 mL of each oil were made up to 100 mL.

For four oil mixture (mixture F), 1.25 mL of each oil were made up to 100 mL.

The method of Example 2 was essentially repeated using these mixtures. Exposure was carried out in polystyrene plate wells containing 5 mL volumes of the test solutions as described in Example 2. The concentrations used were 0.5% and 5.0% v/v of the compositions diluted with aerated tap water with four replicates for each. The control comprised aerated tap water only.

Exposure was started with 0-4 day old J2 nematodes with 2-28 nematodes added per well. Observations for mobility were made after 14 days before and after adding 1 drop of 33% nitric acid to stimulate nematode movement. The data (arcsin square root transformed) were analysed using the ToxCalc computer program by comparing the aerated water only controls with each combination of the plant oils, in turn using appropriate multiple comparison tests (1-tail, P=0.05).

SUMMARY TABLE 5
Mean percentage immobility before and after acid addition on day 14.

| | | % immobile at | % immobile at |
|---|---|---|---|
| | Concentration | day 14 before | day 14 after |
| Treatment | in water (%) | acid addition | acid addition* |
| A Water control | — | 24.2 | 4.7 |
| B | 5.0 | [85.2] | [52.8] |
| C | 5.0 | [100.0] | [72.1] |
| D | 5.0 | [97.2] | [75.5] |
| E | 5.0 | [83.3] | 24.3 |
| F | 5.0 | [92.2] | [68.6] |

Note :
values in bold type and [ ] are significantly different (1-tail, P = 0.05) from the water control.
*after addition of 1 drop of 33% HNO₃

To determine if there were any synergistic effects the results have been compared with those obtained for the single oils as described in Example 2. In order to carry out this comparison both sets of results were corrected for control immobility using Abbott's formula (Abbott W S (1925). A method for computing the effectiveness of an insecticide. J. Econ. Entomology 18, 265-267). Since mobility was determined in Example 1 after acid addition, only the after acid addition results are compared. Only the results at the 5% concentrations are compared since 0.5% did not show significant differences from the controls. A larger % immobility value found for the mixed oils in the present study indicates a synergistic effect (i.e. a greater effect than would have been expected from simple addition of the effects of individual oils). The results are compared in Table 6 below.

TABLE 6

| | % immobility expected from | % immobility | |
|---|---|---|---|
| | results of oils tested | found in Example | |
| | singly in Example 2 - | 3 - Abbott | Synergy |
| Treatment | Abbott corrected | corrected | (Yes/No) |
| B | 71.0 | 50.5 | No |
| C | 77.4 | 70.7 | No |
| D | 71.7 | 74.3 | Yes |
| B | 63.9 | 20.6 | No |
| F | 53.3 | 67.1 | Yes |

The results indicate that, in this trial, palmerosa and tagetes oils in combination are more effective than would have been expected from the results of single oils, i.e. there is a synergistic effect. The same is true for palmerosa+sweet basil+tagetes+thyme.

1. A nematicidal composition comprising (i) one or more essential oils selected from Tagetes erecta oil, Ocimum basilicium (sweet basil) oil or a Cymbopogon martini (palmerosa) oil, or a mixture thereof, or component of any of these, other than eugenol, which have a nematicidal effect (ii) an agriculturally acceptable carrier oil and (iii) an emulsifier.

2. A nematicidal composition according to claim 1 which comprises Cymbopogon martini (palmerosa) oil or Tagetes erecta oil, or a component thereof.

3. A composition according to claim 1 which comprises as component (i) one or more essential oils selected from Tagetes erecta oil, Ocimum basilicium (sweet basil) oil or a Cymbopogon martini (palmerosa) oil, or a mixture thereof.

4. A composition according to claim 3 wherein component (i) comprises a mixture of at least two essential oils selected from Tagetes erecta oil, Ocimum basilicium (sweet basil) oil and Cymbopogon martini (palmerosa) oil.

5. A composition according to claim 4 which comprises Tagetes erecta oil and a Cymbopogon martini (palmerosa) oil, or a mixture thereof

6. A composition according to claim 5 which further comprises Ocimum basilicium (sweet basil) oil and thyme oil.

7. A composition according to claim 1 which comprises no more than 5% w/w of any one essential oil or component thereof.

8. A composition according to claim 7 wherein the composition comprises no more than 2% w/w of the or each essential oil or component thereof.

9. A composition according to claim 4 which contains no more than 6% w/w total essential oil.

10. A composition according to claim 1 wherein the agriculturally acceptable carrier oil is canola oil (OSR), sunflower oil, cottonseed oil, palm oil or soybean oil.

11. A composition according to claim 10 wherein the agriculturally acceptable carrier oil is canola oil.

12. A composition according to claim 1 wherein the emulsifier is a polyoxyethylene sorbitan ester.

13. A composition according to claim 1 wherein the emulsifier is coconut diethanolamide.

14. A composition according to claim 1 which further comprises (iv) a component which remediates symptoms of viral infection.

15. A composition according to claim 14 wherein component (iv) is wintergreen oil.

16. A composition according to claim 14 wherein the composition comprises up to 1% w/w of component (iv).

17. A formulation for administration to soil containing or suspected of containing nematode pests, a formulation comprising a composition according to claim 1 and water.

18. A method for killing or controlling nematodes which method comprises applying to the nematodes or to the locus thereof, a composition according to claim 1.

19. A method according to claim 18 wherein the nematodes are wheat nematodes {Anguina tritici), grass seed nematodes (Anguina agrostis)ᵣ Spring dwarf nematodes (Aphelenchoides fragariae), pine wood nematodes (Bursaphelenchus xylophylus), chrysanthemum nematodes {Aphelenchoides ritzema-bosi), bulb and stem nematodes (Ditylenchus dipsaci), potato rot nematodes {Ditylenchus destructor), root lesion nematodes (Pratylenchus ap.), root-knot nematodes {Meloidogyne sp.)ᵣ Cyst nematodes (Heterodera sp.), cyst nematodes [Globodera spp.), stubby-root nematodes (Trycodorus sp), dagger nematodes (Xiphinema sp.), needle nematodes (Longidorus sp.), pin nematodes {Paratylenchus sp.), stunt nematodes (Tylenchorhynchus sp.), lance nematodes (Hoplolaimus sp.), spiral nematodes (Helicotylenchus sp.) and ring nematodes (Criconema sp.).

20. A method according to claim 19 wherein the nematodes are bulb and stem nematodes (Ditylenchus dipsaci), potato rot nematode (Ditylenchus destructor), root lesion nematodes (Pratylenchus sp.), root-knot nematodes (Meloidogyne sp.), cyst nematodes (Heterodera sp.) or cyst nematodes (Globodera spp.)

21. A method according to claim 18 wherein the composition or formulation is applied in combination with another agrochemical.

22. The use of a composition according to claim 1 as a nematicide, for administration to soil at a rate of less than 20 litres per hectare
